(19) United States
(12) Patent Application Publication
(10) Pub. No.: US 2007/0053259 A1
(43) Pub. Date: Mar. 8, 2007

(54) WRITE STRATEGY DIRECTORY AND METHOD FOR MAINTAINING THE SAME

(75) Inventors: Chien-Li Hung, Hsinchu (TW); Ling-Feng Chen, Hsinchu (TW)

Correspondence Address: KIRTON AND MCCONKIE, 60 EAST SOUTH TEMPLE,, SUITE 1800, SALT LAKE CITY, UT, 84111, US

(73) Assignee: LITE-ON IT CORP., Taipei City (TW)

(21) Appl. No.: 11/466,939

(22) Filed: Aug. 24, 2006

(30) Foreign Application Priority Data
Sep. 6, 2005 (TW) 094130596

(51) Int. Cl. G11B 19/00

(52) U.S. Cl. 369/47.5

(57) ABSTRACT

A write strategy directory is stored in an optical recorder to provide optimum write strategies for the optical recorder to write optical discs according to characteristic values of the optical discs, respectively. The write strategy directory includes a fixed write strategy table recording therein first characteristic values of a first group of optical discs and first write strategies corresponding to the first characteristic values, respectively; and a modifiable strategy table independent from the fixed write strategy table, recording therein second characteristic values of a second group of optical discs and second write strategies corresponding to the second characteristic values, respectively.

### FIELD OF THE INVENTION

The present invention relates to a write strategy directory for use in an optical writing apparatus to write an optical disc with an optimum write strategy. The present invention relates to a method for maintaining a write strategy directory to be adapted to various optical discs.

### BACKGROUND OF THE INVENTION

There are two major types of optical discs in current market, i.e. CD (Compact Disc) and DVD (Digital Video Disc or Digital Versatile Disc) among a variety of optical discs. CD and DVD can also be classified into many types and specifications according the read/write functions they support. For example, CD can be classified into CD-ROM, Photo CD, CD-R/RW, VCD, Super VCD, etc.; and DVD can be classified into DVD-Video, DVD-Audio, DVD-ROM, DVD-RAM, DVD+R/-R, DVD+RW/-RW, DVD-DL, etc., wherein CD-R and DVD+R/-R can be written for only one time, but CD-RW and DVD+RW/-RW can be rewritten over and over.

Beside, different CD and DVD manufacturers may use different producing processes, and the sensitivities or qualities of recorded data could be significantly affected by the formulae or compositions of dyes coated on the optical discs. In recent years, some of the manufacturers of the optical discs may use inferior and cheaper compositions to produce the optical discs in order to survival in price erosive and severely competitive market. Thus the quality of the optical discs in market has great variation. The optical discs made by inferior compositions have much difficulty to be acquainted by the optical recorders. The written data on the inferior optical discs have the lower quality and more errors when the optical recorders try to read the written data on the inferior discs. An excellent optical recorder must try the effort to overcome the quality variation of the inferior optical discs.

Therefore, optical recorder manufacturers usually collect various types of optical discs in market and manage information of these discs, then build up a write strategy table that records the information about the writing processes and writing ways of different types and specifications of optical discs produced by different manufacturers for optimal power calibration. In practice, the serial number of a recordable optical disc will be checked first before the data-writing procedure is performed. According to the serial number, corresponding recording parameters (e.g., pulse width) are located by looking up the write strategy table so as to determine an optimal recording power for data writing. As such, a single optical recorder can be adapted to various optical discs produced by different manufacturers in market. As for those optical discs having not been included in the write strategy table, they are generally written with predetermined rather than optimized default. Therefore, the quality of the recorded data would be not good enough.

As new optical discs and new optical disc manufacturers appear day by day, it is impossible to include information of all optical discs in market in the built-in write strategy table. Since the optical recorders made in early days may not process the newly developed optical discs, the write strategy for writing these optical discs would not be optimized. For fixing the problem, the optical recorder manufacturers modify the write strategy tables by updating the firmware of the optical recorders after acquiring updated information of optical discs from consumers or any other source. The updated firmware needs verifying through the DQA (Data Quality Assessment) of the testing and verifying department before being available for users, for example via Internet.

It is understood that the firmware plays the most important role for assuring of the normal operation of the recorder. Therefore, the verification of firmware has to be executed seriously to avoid any inappropriate firmware updating operations. Thus, the updating operation of the firmware to obtain the updated write strategy table is complicated and time-consuming. In other words, the speed of firmware updating can't keep up with the appearing speed of new optical disc.

### SUMMARY OF THE INVENTION

Therefore, the present invention provides a write strategy directory including a write strategy table that can be updated easily and conveniently.

The present invention also provides a method for maintaining the write strategy directory.

The present invention relates to update a write strategy directory stored in an optical recorder to provide optimum write strategies for the optical recorder to write optical discs according to characteristic values of the optical discs. The write strategy directory comprises a fixed write strategy table recording therein first characteristic values of a first group of optical discs and first write strategies corresponding to the first characteristic values, respectively; and a modifiable strategy table independent from the fixed write strategy table, recording therein second characteristic values of a second group of optical discs and second write strategies corresponding to the second characteristic values, respectively.

In an embodiment, the fixed write strategy table is a part of a firmware stored in a code flash memory of the optical recorder. The modifiable write strategy table can also be stored in the code flash memory but in a divided zone from the fixed write strategy table so that the modification of the modifiable write strategy table would not have any effect on the operation of the firmware.

Alternatively, the modifiable write strategy table can be stored in another nonvolatile memory of the optical recorder, e.g. a data flash memory or an EEPROM.

For example, the characteristic values of the optical discs to be written and the first and second characteristic values stored in the fixed and modifiable write strategy tables are selected from a group consisting of specifications, types, applicable speed, model names and assigned numbers. On the other hand, the first and second write strategies recorded in the fixed and modifiable write strategy tables include parameters selected from a group consisting of powers and pulse width for writing the optical discs.

The present invention also relates to a method for maintaining a write strategy directory of an optical recorder. The write strategy directory comprises a built-in write strategy table and an auxiliary write strategy table. The method comprises steps of: comparing a characteristic value of an optical disc with characteristic values in the built-in write strategy table and the auxiliary write strategy table when the optical disc is loaded into the optical recorder; requesting information corresponding to the optical disc from the manufacturer of the optical recorder when there is no conformable characteristic value found in the built-in write strategy table and the auxiliary write strategy table; and updating the auxiliary write strategy table to include the characteristic value and a corresponding write strategy of the optical disc.

Preferably, in the comparing step, the characteristic value of the optical disc is automatically compared with the characteristic values recorded in the auxiliary write strategy table first by the optical recorder upon the insertion of the optical disc, and then the characteristic value of the optical disc is automatically compared with the characteristic values recorded in the built-in write strategy table by the optical recorder if there is no conformable characteristic value found in the auxiliary write strategy table.

Preferably, in the information-requesting step, an application program is automatically executed by the optical recorder to show contact information of the manufacturer of the optical recorder and/or inquire a desired updating way from the user.

Preferably, in the updating step, the auxiliary write strategy table is updated online or with an installation optical disc.

In an embodiment, the built-in write strategy table is created as a part of a firmware. In the updating step, the auxiliary write strategy table is updated while the firmware remains unchanged.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a functional block diagram schematically illustrating a computer system capable of reading/writing optical disc;

FIG. 2 is a block diagram schematically illustrating divisions of an optical disc;

FIG. 3(a) is a block diagram illustrating a write strategy directory according to an embodiment of the present invention;

FIG. 3(b) is a block diagram schematically illustrating a first table of the write strategy directory of FIG. 3(a);

FIG. 3(c) is a block diagram schematically illustrating a second table of the write strategy directory of FIG. 3(a);

FIG. 4(a) is a block diagram illustrating a write strategy directory according to another embodiment of the present invention;

FIG. 4(b) is a block diagram illustrating a write strategy directory according to a further embodiment of the present invention; and

FIG. 5 is a flowchart illustrating a method for maintaining a write strategy directory according to an embodiment of the present invention.

### DETAILED DESCRIPTION OF THE PREFERRED EMBODIMENT

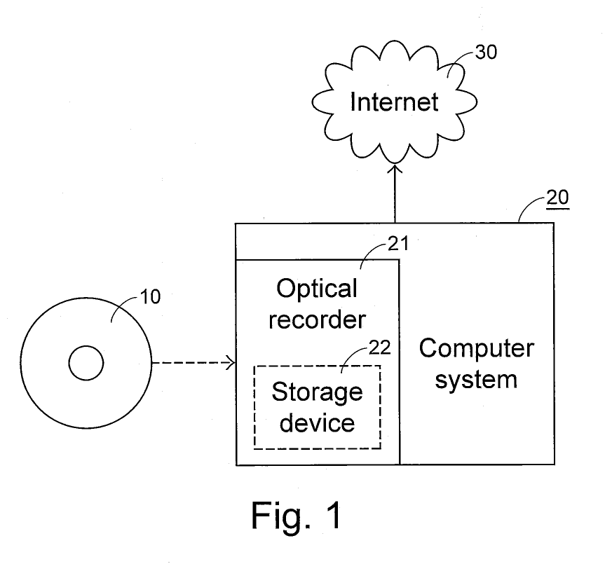

For avoiding the necessity of modifying firmware, the present invention provides an auxiliary write strategy table that can be readily updated with the diversification of optical discs in addition to the built-in write strategy table. When an optical disc 10 (FIG. 1) is inserted into the optical recorder 21 of a computer system 20 to be written, the optical disc 10 is identified first by referring to the built-in write strategy table and/or the auxiliary write strategy table so as to locate the corresponding optimum write strategy. A write strategy directory including the built-in write strategy table and the auxiliary write strategy table can be stored in a non-volatile storage device 22 in the optical recorder 21. It is preferred that the computer system can access to the Internet 30 so that the auxiliary write strategy table can be updated online.

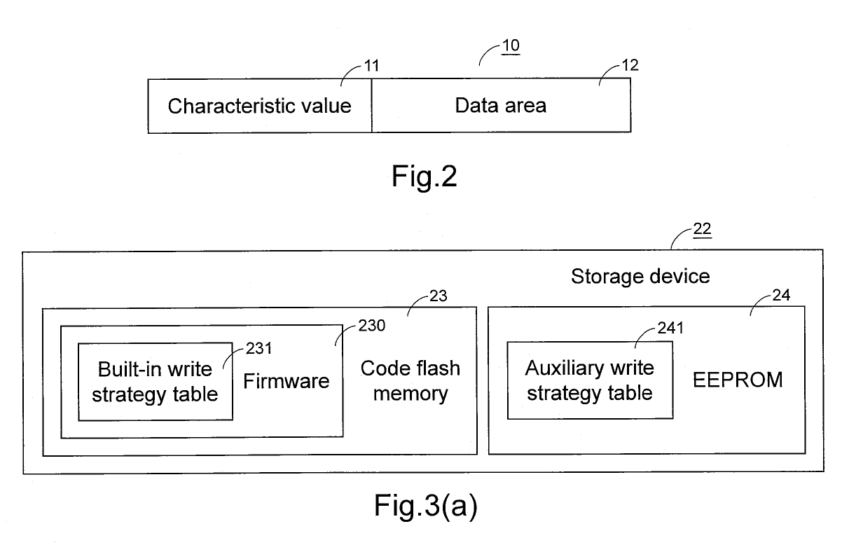

The identification of the optical disc is made by checking a characteristic value of the optical disc. Please refer to FIG. 2. An optical disc 10 generally records therein a characteristic value 11 apart from the data area 12 so that different brands or different types of optical discs can be distinguished. The characteristic value 11, for example, indicates specification, type (such as CD-RW or DVD+RW/-RW), applicable speed, model name and/or assigned number (such as serial number). Since different brands or different types of optical discs have their own optimum writing strategies, it is preferred to identify the optical disc currently processed in advance by checking the characteristic value 11. Then, the optical recorder 21 can write data into the data recording area 12 of the optical disc according to the optimum write strategy.

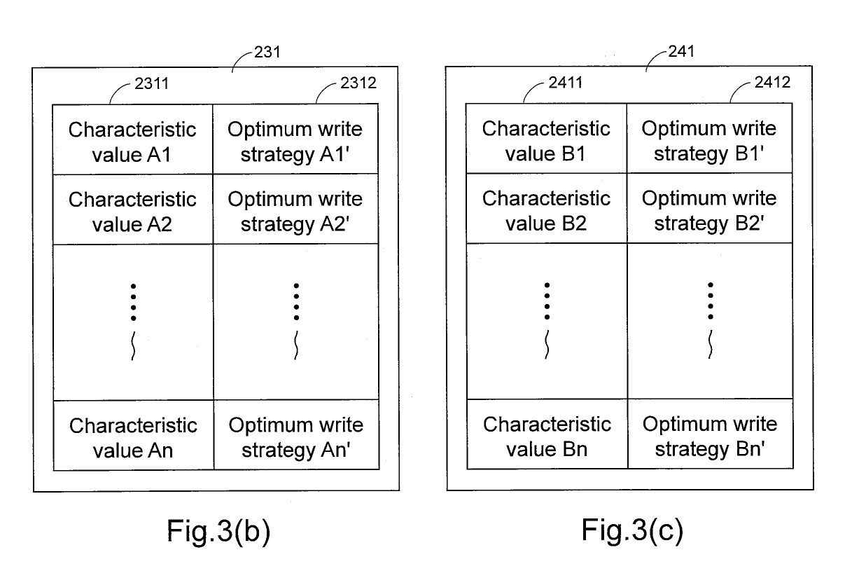

Please refer to FIG. 3(a), in which an embodiment of the write strategy directory according to the present invention is illustrated, together with FIG. 1. The write strategy directory includes a built-in strategy table 231 recorded in a Code Flash Memory 23 of the storage device 22 as a part of a firmware 230 and an auxiliary write strategy table 241 recorded in an EEPROM 24 of the storage device 22. The firmware 230 controls the operation of the entire optical recorder 21. The built-in write strategy table 231 is a database as shown in FIG. 3(b), which is created and maintained, if necessary, by the manufacturer because it involves in complicated firmware modification and verification. On the other hand, the auxiliary write strategy table 241 is a database able to be readily updated by users, as shown in FIG. 3(c). When the information of a specified optical disc is absent from the built-in write strategy table 231, it can be requested and then stored into the EEPROM 24 to update the auxiliary write strategy table 241 for current and future use. The updating operation of the auxiliary write strategy table 241 for incorporating the information of the optical disc of interest, for example, can be performed online or with an installation disc. The newly incorporated information should include a characteristic value, e.g. characteristic value Bn in FIG. 3(b), and its optimum write strategy, e.g. write strategy Bn′ in FIG. 3(c).

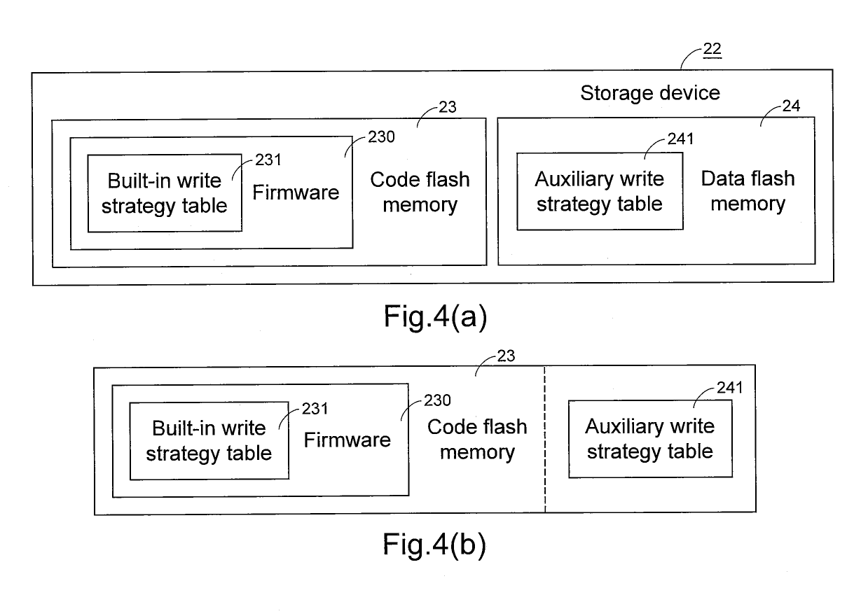

Alternatively, the auxiliary write strategy table 241 can be recorded in any other suitable non-volatile memory such as Data Flash Memory (FIG. 4(a)) or a divided portion of the Code Flash Memory 23 (FIG. 4(b)).

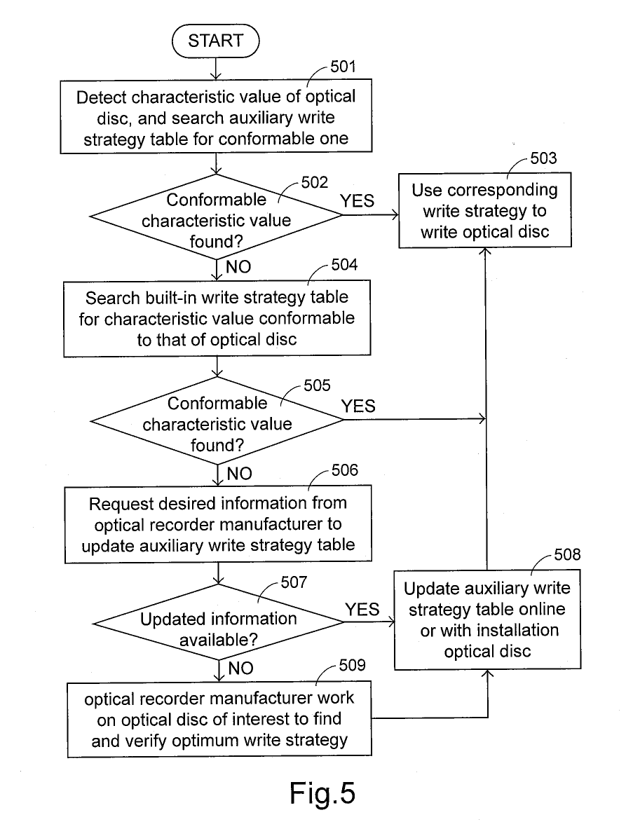

The maintenance of the write strategy directory according to the present invention will be described herein with reference to the flowchart of FIG. 5. When the optical disc 10 is inserted into the optical recorder 21, the optical recorder 21 will detect the characteristic value 11 of the optical disc 10, and search the auxiliary write strategy table 241 for conformable one (Step 501). If a conformable characteristic value is found from the auxiliary write strategy table 241 (Step 502), the corresponding optimum write strategy can be realized from the same table. The associated parameters of the optimum write strategy are then used to write data into the optical disc (Step 503). On the other hand, if there is no conformable characteristic value found in the auxiliary write strategy table 241 (Step 502), check the built-in write strategy table 231 (Step 504). If a conformable characteristic value is found (Step 505), use corresponding optimum write strategy to write data into the optical disc (Step 503). Otherwise, the user should request desired information from the optical recorder manufacturer to update the auxiliary write strategy table 241 (Step 506), as previously described. If there has been updated information available (Step 507), the user may update the auxiliary write strategy table 241 online or with an optical disc (Step 508). Then, the optical recorder 21 can process the optical disc with optimum write strategy (Step 503). If there has not been updated information available (Step 507), the optical recorder manufacturer may need to work on the optical disc of interest (Step 509) in order to be able to provide the users undated information to be downloaded online or installed with an optical disc (Step 508).

When there is no conformable characteristic value found in the write strategy directory, an application program is preferably automatically executed in the computer system by the optical recorder to show contact information of the manufacturer of the optical recorder and/or inquire a desired updating way from the user. For example, the website address, email address and telephone number of the manufacturer are shown and the user can select “live update” or “request disc for update”, etc. The user may need to inform the manufacturer of product information associated with the optical disc, e.g. make, model number, specification and type, etc.

In the above embodiment of write strategy maintenance method, the auxiliary write strategy table 241 is checked prior to the built-in write strategy table 231. Alternatively, it is also feasible to have the built-in write strategy table 231 checked first, and then the auxiliary write strategy table 241. Basically, it would be better if the auxiliary write strategy table 241 is checked first because the information in the auxiliary write strategy table 241 is generally more advanced than that in the built-in write strategy table 231 and the most recently updated information is always stored in the auxiliary write strategy table 241. On the other hand, instead of updating the write strategy directory while a certain optical disc is loaded into the optical recorder, the auxiliary write strategy table can also be updated in advance, for example in response to the user's request or the manufacturer's notice.

It is understood from the above descriptions that the method for maintaining a write strategy directory comprising of a built-in write strategy table and an auxiliary write strategy table does not need to process the time-consuming and complicated verification of firmware in the built-in write strategy table for updating some write strategies. Instead, it just needs to have the auxiliary write strategy table updated, which can be readily implemented.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A write strategy directory stored in an optical recorder to provide optimum write strategies for the optical recorder to write optical discs according to characteristic values of the optical discs, respectively, the write strategy directory comprising:
a fixed write strategy table recording therein first characteristic values of a first group of optical discs and first write strategies corresponding to the first characteristic values, respectively; and
a modifiable strategy table independent from the fixed write strategy table, recording therein second characteristic values of a second group of optical discs and second write strategies corresponding to the second characteristic values, respectively.

2. The write strategy directory according to claim 1 wherein the fixed write strategy table is a part of a firmware.

3. The write strategy directory according to claim 1 wherein the fixed write strategy table is built in a code flash memory of the optical recorder.

4. The write strategy directory according to claim 1 wherein the modifiable write strategy table is stored in a nonvolatile memory of the optical recorder.

5. The write strategy directory according to claim 4 wherein the modifiable write strategy table is stored in a data flash memory of the optical recorder.

6. The write strategy directory according to claim 4 wherein the modifiable write strategy table is stored in an EEPROM of the optical recorder.

7. The write strategy directory according to claim 4 wherein the fixed write strategy table and the modifiable write strategy table are stored in divided zones of a code flash memory of the optical recorder.

8. The write strategy directory according to claim 1 wherein the characteristic values of the optical discs to be written and the first and second characteristic values recorded in the fixed and modifiable write strategy tables are selected from a group consisting of specifications, types, applicable speed, model names and assigned numbers.

9. The write strategy directory according to claim 1 wherein the first and second write strategies recorded in the fixed and modifiable write strategy tables include parameters selected from a group consisting of powers and pulse width for writing the optical discs.

10. A method for maintaining a write strategy directory of an optical recorder, the write strategy directory comprising a built-in write strategy table and an auxiliary write strategy table, and the method comprising steps of:
comparing a characteristic value of an optical disc with characteristic values recorded in the built-in write strategy table and the auxiliary write strategy table when the optical disc is loaded into the optical recorder;
requesting information corresponding to the optical disc from the manufacturer of the optical recorder when there is no conformable characteristic value found in the built-in write strategy table and the auxiliary write strategy table; and
updating the auxiliary write strategy table to include the characteristic value and a corresponding write strategy of the optical disc.

11. The method according to claim 10 wherein in the comparing step, the characteristic value of the optical disc is automatically compared with the characteristic values recorded in the auxiliary write strategy table first by the optical recorder upon the insertion of the optical disc, and then the characteristic value of the optical disc is automatically compared with the characteristic values recorded in the built-in write strategy table by the optical recorder if there is no conformable characteristic value found in the auxiliary write strategy table.

12. The method according to claim 10 wherein in the information-requesting step, an application program is automatically executed by the optical recorder to show contact information of the manufacturer of the optical recorder and/or inquire a desired updating way from the user.

13. The method according to claim 10 wherein in the updating step, the auxiliary write strategy table is updated online.

14. The method according to claim 10 wherein in the updating step, the auxiliary write strategy table is updated with an installation optical disc.

15. The method according to claim 10 wherein the built-in write strategy table is created as a part of a firmware.

16. The method according to claim 15 wherein in the updating step, the auxiliary write strategy table is updated while the firmware remains unchanged.
